(19) United States
(12) Patent Application Publication
(10) Pub. No.: US 2012/0242094 A1
(43) Pub. Date: Sep. 27, 2012

(54) FIXING MECHANISM WITH SWING OPERATION

(76) Inventors: Chen-Yi Liang, New Taipei City (TW); Cheng-Hsiang Chuang, New Taipei City (TW); Chun-Chien Chen, New Taipei City (TW); Shun-De Bai, New Taipei City (TW); San-Pao Kao, New Taipei City (TW)

(21) Appl. No.: 13/417,327

(22) Filed: Mar. 12, 2012

(30) Foreign Application Priority Data
Mar. 25, 2011 (TW) 100110301

(51) Int. Cl. E05C 19/10

(52) U.S. Cl. 292/117; 292/96

(57) ABSTRACT

A fixing mechanism for fixing a component is disclosed. The fixing mechanism includes a base, a lateral wall disposed on the base, and a top plate connected to the lateral wall. A containing space is formed between the base, the lateral wall, and the top plate. The top plate presses against the component in a first direction and the lateral wall abuts against the component laterally when the component is contained inside the containing space. The fixing mechanism includes at least one hook. The hook includes a cantilever portion and a hooking portion. The cantilever portion is disposed on a side of the base, and a distance between the cantilever portion and the base is greater than a distance between the top plate and the base. The hooking portion engages with a lateral surface of the component in a second direction when the component is contained inside the containing space.

### BACKGROUND OF THE INVENTION

1. Field of the Invention

The disclosure relates to a fixing mechanism for fixing a component, and more particularly, to a fixing mechanism for assembling a component in a direction different from a loosing direction of a hook thereof.

2. Description of the Prior Art

Generally speaking, when a notebook computer is close, a latch mechanism is used for latching a monitor and a host in order to fix the monitor and the host. For example, a conventional latch mechanism utilizes a magnetic component to combine the monitor and the host. The magnetic component is often fastened by glue or hooks. It has disadvantages of overflow of glue, high cost, and viscosity reduction of the glue due to temperature increase. Furthermore, the assembly direction of the conventional magnetic component is the same as the lift direction of the hook, so that the magnetic component compresses the hook backwards resulting in loss of function of fastening the magnetic component by the hook. On the other hand, for easy assembly of the magnetic component, the size of the hook can be reduced, but it causes possibility of loosing the magnetic component. Thus, design of a fixing mechanism with low assembly cost and better fastening effect for the magnetic component is an important issue of the mechanical industry.

### SUMMARY OF THE INVENTION

The disclosure provides a fixing mechanism for assembling a component in a direction different from a loosing direction of a hook thereof for solving above drawbacks.

According to the claimed disclosure, a fixing mechanism for fixing a component is disclosed. The fixing mechanism includes a base, a lateral wall disposed on the base, and a top plate connected to the lateral wall. A containing space is formed between the base, the lateral wall, and the top plate. The top plate presses against the component in a first direction and the lateral wall abuts against the component laterally when the component is contained inside the containing space. The fixing mechanism includes at least one hook. The hook includes a cantilever portion and a hooking portion. The cantilever portion is disposed on a side of the base, and a distance between the cantilever portion and the base is greater than a distance between the top plate and the base so that the component does not push the cantilever portion to lift toward a direction opposite to the first direction as the component is contained inside the containing space. The hooking portion engages with a lateral surface of the component in a second direction different from the first direction as the component is placed to be contained inside the containing space in the second direction.

According to the claimed disclosure, the fixing mechanism further includes at least one guiding rail disposed on the base and connected to the at least one lateral wall, for guiding the component to place into the containing space in the second direction.

According to the claimed disclosure, an inclined structure is formed on an end of the at least one guiding rail.

According to the claimed disclosure, the cantilever portion is integrated with the top plate monolithically.

According to the claimed disclosure, the fixing mechanism comprises threes hooks, one hook is connected to a side of the top plate, and the other two hooks are connected to another side of the top plate.

According to the claimed disclosure, the cantilever portion is connected to the top plate, and a slot is formed on the cantilever portion and the top plate.

According to the claimed disclosure, two notches are formed on the top plate and connected to the slot.

According to the claimed disclosure, an included angle between the hooking portion and the cantilever portion is substantially greater than, equal to, or less than 90 degrees.

In the disclosure, there is no need to utilize glue to fasten the component, such as the magnetic component for latching the monitor and the host, for solving problems in the prior art. Furthermore, because the distance between the cantilever portion of the hook and the base is greater than the distance between the top plate and the base, the top plate can contact against the component and the cantilever portion can not contact against the component as the component is applied by external force, such as being attracted by other magnetic component. It can prevent deformation of the hook. Besides, the assembly direction of the component is different from the releasing direction of the hook lifted upwards so that the component can not lift the hook as being contained inside the containing space and the hook can fasten the component stably. Thus, the disclosure provides a fixing mechanism with low assembly cost and preferred fastening effect.

These and other objectives of the disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 and FIG. 2 are schematic drawings respectively showing a portable computer in open and close conditions according to an embodiment of the disclosure.

FIG. 3 is an enlarged diagram of a fixing mechanism according to a first embodiment of the disclosure.

FIG. 4 to FIG. 6 are assembly diagrams illustrating the fixing mechanism fixing a component according to the first embodiment of the disclosure.

FIG. 7 to FIG. 11 are assembly and disassembly diagrams illustrating a fixing mechanism fixing a component according to a second embodiment of the disclosure.

FIG. 12 to FIG. 14 are assembly and disassembly diagrams illustrating a fixing mechanism fixing a component according to a third embodiment of the disclosure.

FIG. 15 to FIG. 17 are assembly and disassembly diagrams illustrating a fixing mechanism fixing a component according to a fourth embodiment of the disclosure.

### DETAILED DESCRIPTION

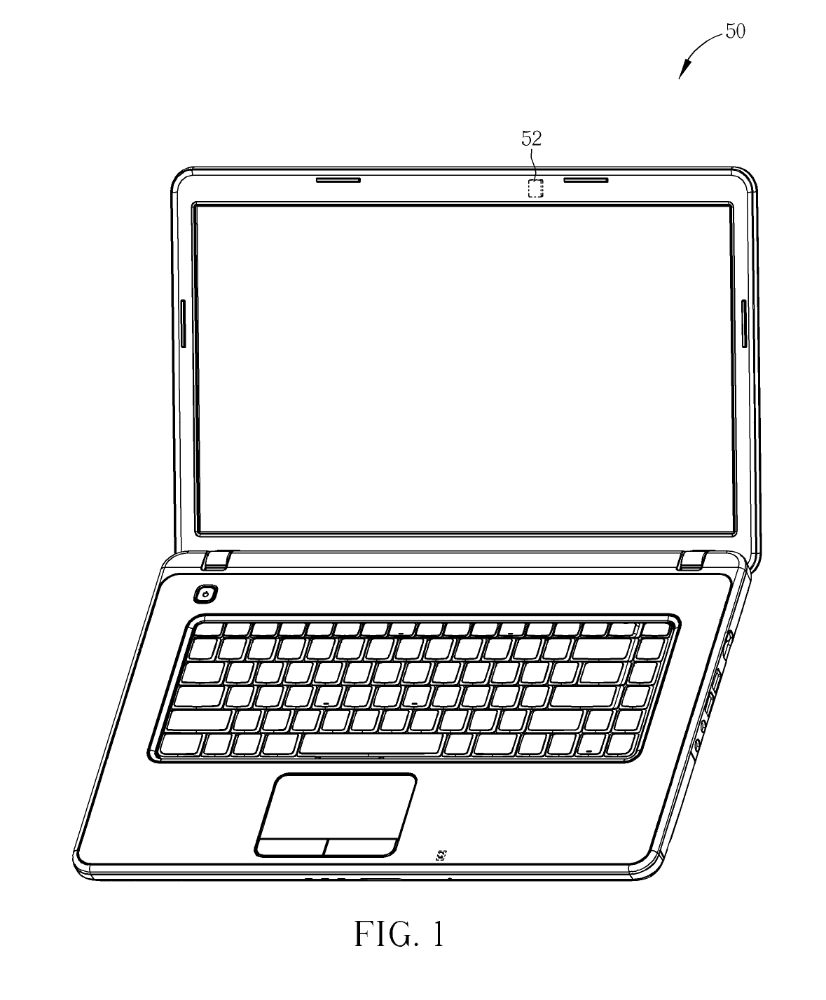

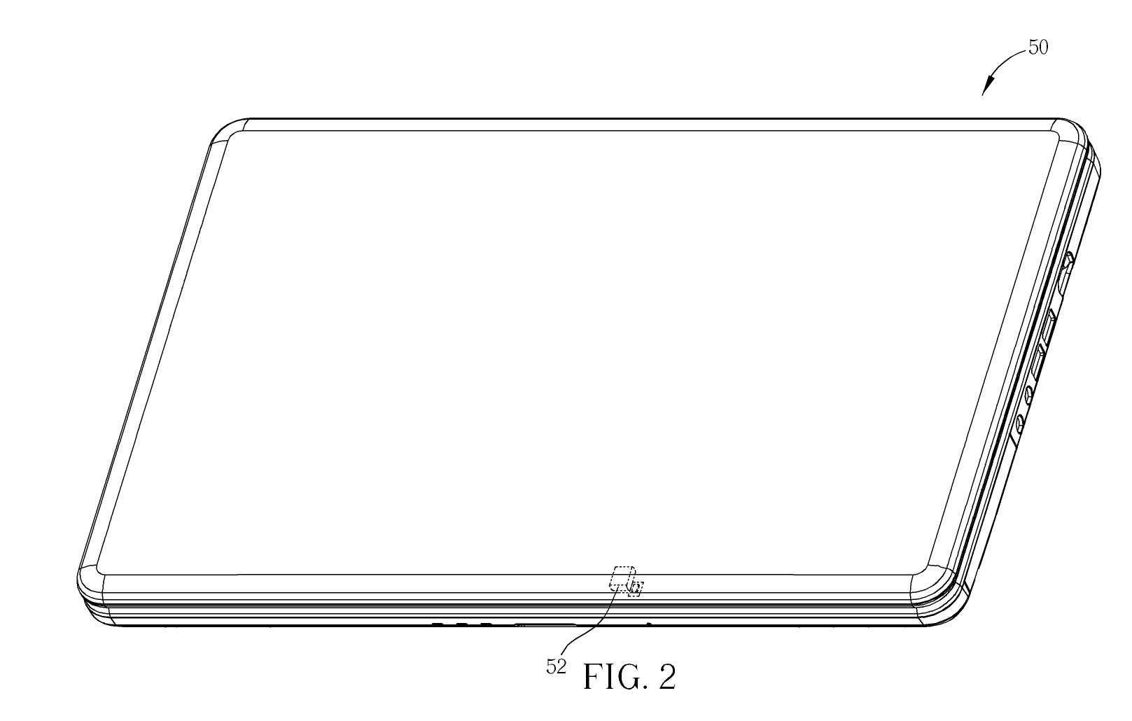

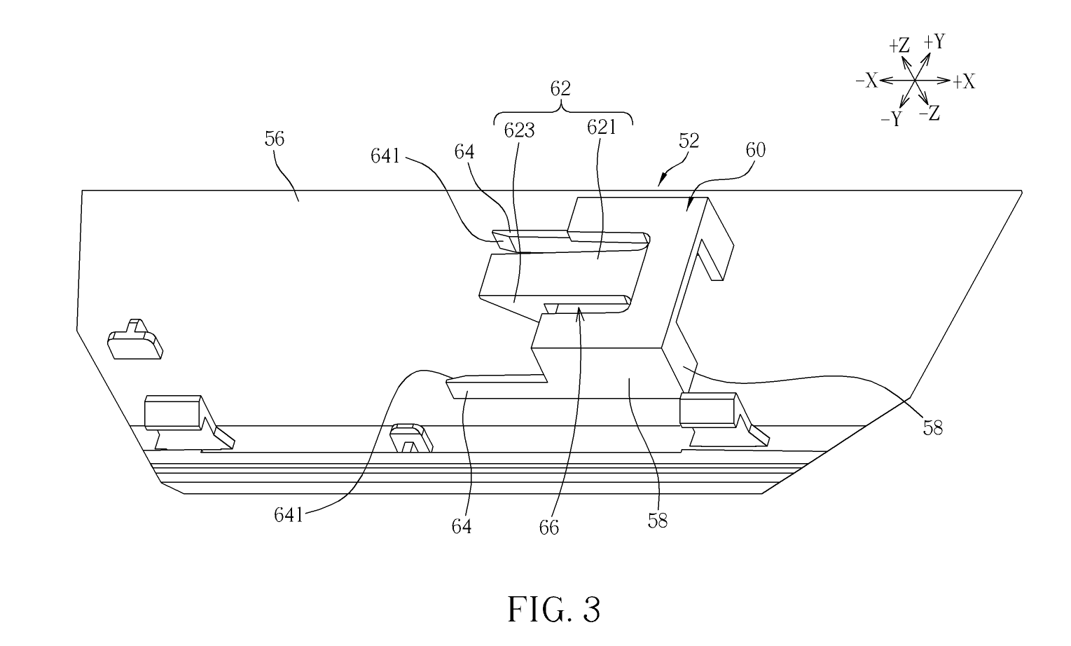

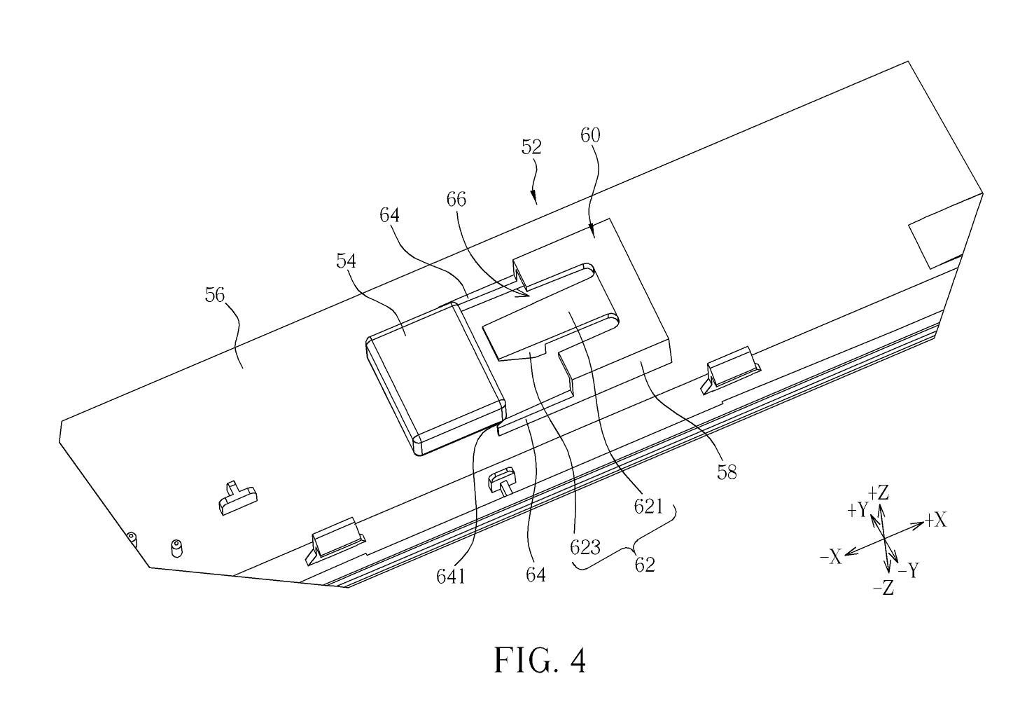

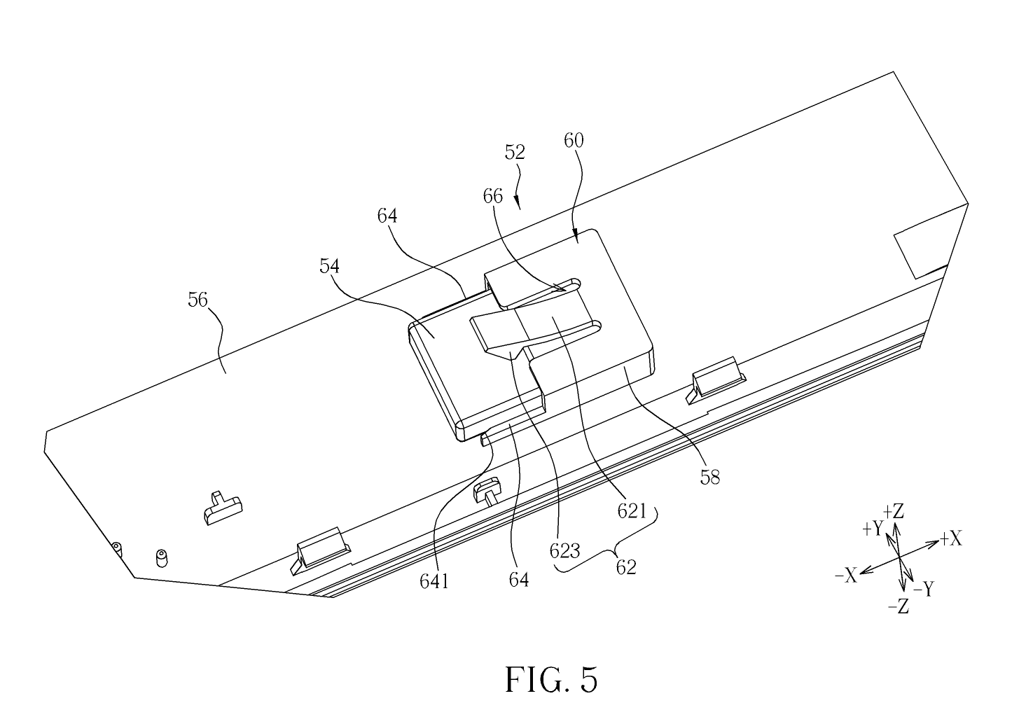

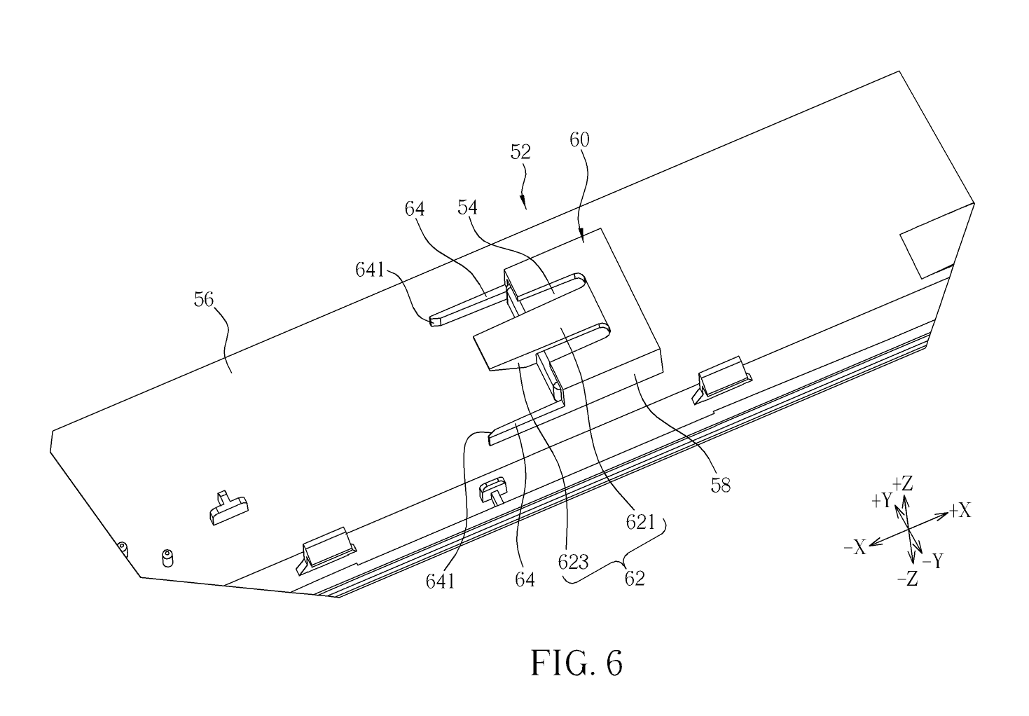

Please refer to FIG. 1 and FIG. 2. FIG. 1 and FIG. 2 are schematic drawings respectively showing a portable computer 50 in open and close conditions according to an embodiment of the disclosure. The portable computer 50 can be a notebook computer. The portable computer 50 includes a fixing mechanism 52 for fixing a component, such as a magnetic component for latching a host and a monitor with magnetic attractive force. The fixing mechanism 52 can be installed on the host or the monitor. Please refer to FIG. 3 to FIG. 6. FIG. 3 is an enlarged diagram of the fixing mechanism 52 according to a first embodiment of the disclosure. FIG. 4 to FIG. 6 are assembly diagrams illustrating the fixing mechanism 52 fixing a component 54 according to the first embodiment of the disclosure. The component 54 can be a magnetic component, such as a magnet. The fixing mechanism 52 includes a base 56, at least one lateral wall 58, a top plate 60, a hook 62, and at least one guiding rail 64. Each lateral wall 58 is disposed on the base 56, and the top plate 60 is connected to the lateral walls 58. A containing space 66 is formed between the base 56, the lateral walls 58, and the top plate 60 for containing the component 54. The hook 62 includes a cantilever portion 621 and a hooking portion 623. The cantilever portion 621 is disposed on a side of the base 56 and connected to the top plate 60 in this embodiment. For example, the cantilever portion 621 can be integrated with the top plate 60 monolithically. A distance between the cantilever portion 621 and the base 56 is greater than a distance between the top plate 60 and the base 56, that is, there is a height difference between the cantilever portion 621 and the top plate 60. Accordingly, as the component 54 is contained inside the containing space 66, the top plate 60 can press down the component 54 in a first direction (−Z direction) and the component 54 does not push the cantilever portion 621 to lift toward a direction opposite to the first direction (+Z direction). The hooking portion 623 is connected to the cantilever portion 621 for engaging with a lateral surface of the component 54 in a second direction (+X direction) different from the first direction as the component 54 is placed to be contained inside the containing space 66 in the second direction (+X direction). An included angle between the hooking portion 623 and the cantilever portion 621 can be substantially greater than, equal to, or less than 90 degrees. Two guiding rails 64 are disposed on the base 56 and respectively connected to the lateral walls 58, for guiding the component 54 to place into the containing space 66 in the second direction (+X direction). An inclined structure 641 can be formed on an end of the guiding rail 64 for guiding the component 54 to slide into the guiding rails 64 therebetween smoothly.

For fixing the component 54 with the fixing mechanism 52, the component 54 is placed between the two guiding rails 64 manually or by a jig to slide into the containing space 66 in the second direction (+X direction) as being guided by the guiding rails 64. The component 54 lifts the hook 62 upwards along an inclined surface of the hooking portion 623 of the hook 62 when being pushed inwards along the guiding rails 64. The component 54 is contained inside the containing space 66 entirely when the component 54 is pushed inwards in +X direction to the end of the lateral wall 58, and the component 54 can not lift the hook 62 anymore so that the hook 62 recovers to an undeformed position resiliently and the hooking portion 623 engages the lateral surface of the component 54 in +X direction. When the component 54 is contained inside the containing space 66, the top plate 60 presses against the component 54 in −Z direction for preventing the component 54 from separating from the containing space 66 upwards. Because the distance between the cantilever portion 621 and the base 56 is greater than the distance between the top plate 60 and the base 56, the top plate 60 can contact against the component 54 and the cantilever portion 621 can not contact against the component 54. Accordingly, the component 54 only abuts against the top plate 60 in +Z direction instead of lifting the cantilever portion 621 upwards in +Z direction as being applied by external force, such as being attracted by other magnetic component, and it can prevent deformation of the hook 62. Besides, the assembly direction (+X direction) of the component 54 to the containing space 66 is different from the releasing direction (+Z direction) of the hook 62 lifted upwards so that the component 54 can not lift the hook 62 and the hook 62 can fasten the component 54 stably. Furthermore, the lateral walls 58 can laterally abut against the component 54 in ±Y direction and −X direction when the component 54 is contained inside the containing space 66, and the hooking portion 623 of the hook 62 can engage the lateral surface of the component 54 in the assembly direction (+X direction) , so that the component 54 can be contained inside the containing space 66 stably by the lateral walls 58, the top plate 60 and the hook 62. As for disassembling the component 54, the hook 62 can be lifted upwards and the component 54 can be pulled out in −X direction, and the hook 62 can resiliently recover to the undeformed position after taking out the component 54.

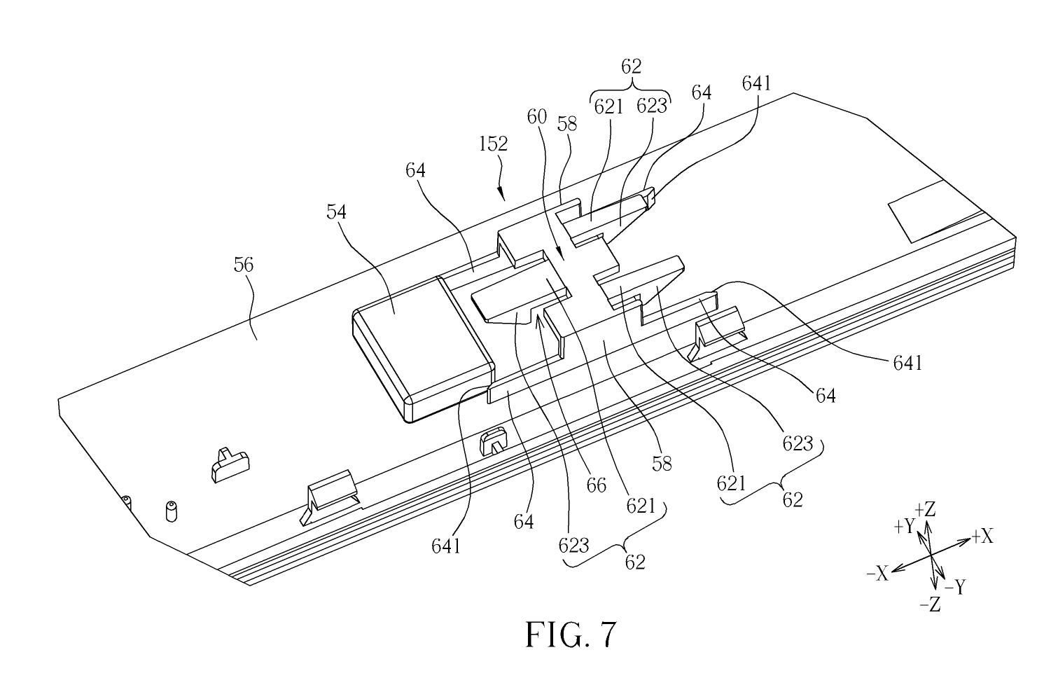

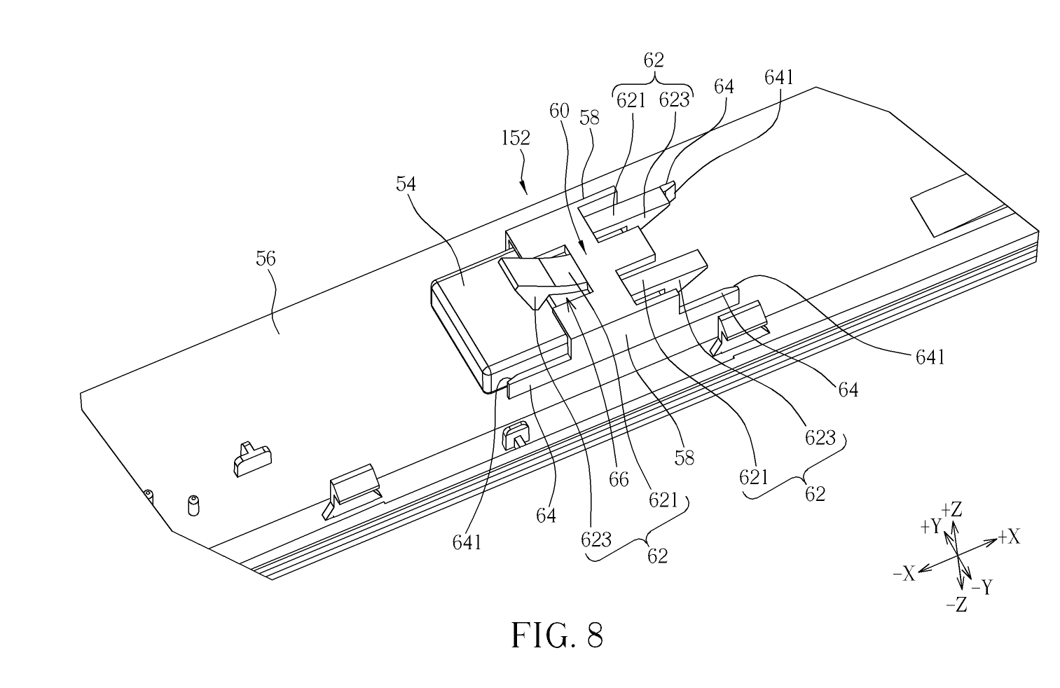

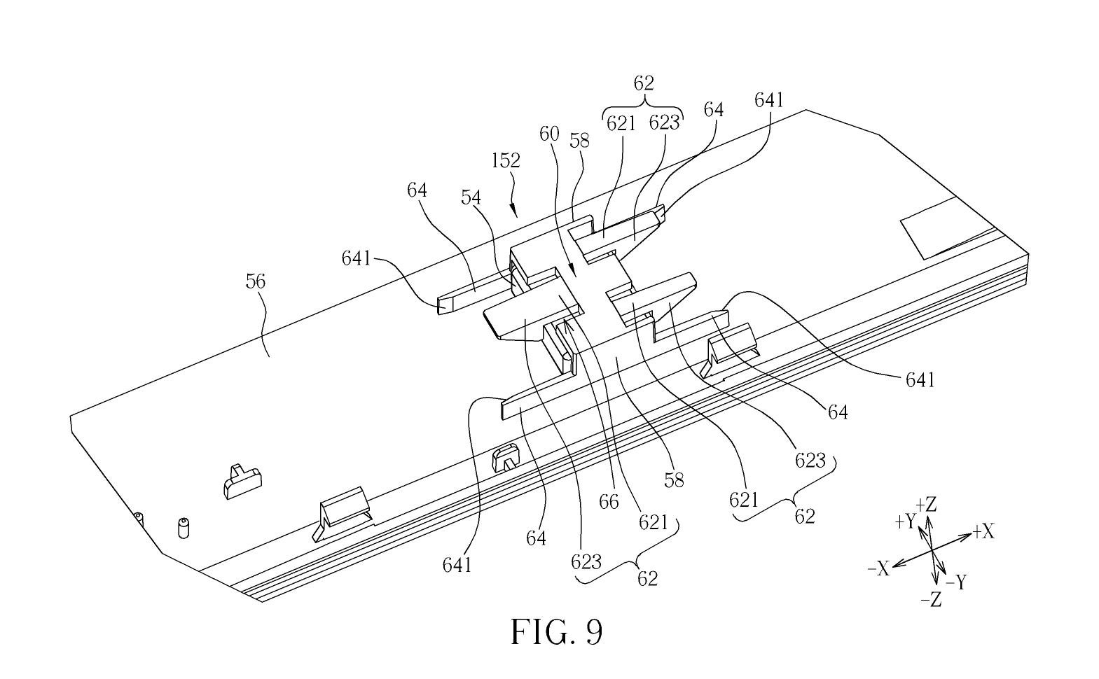

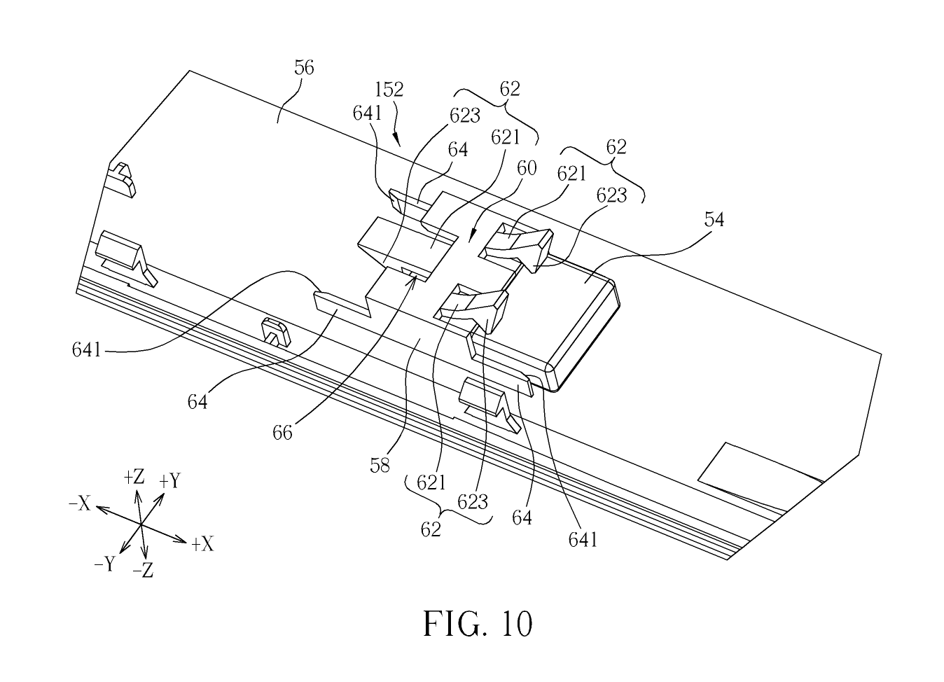

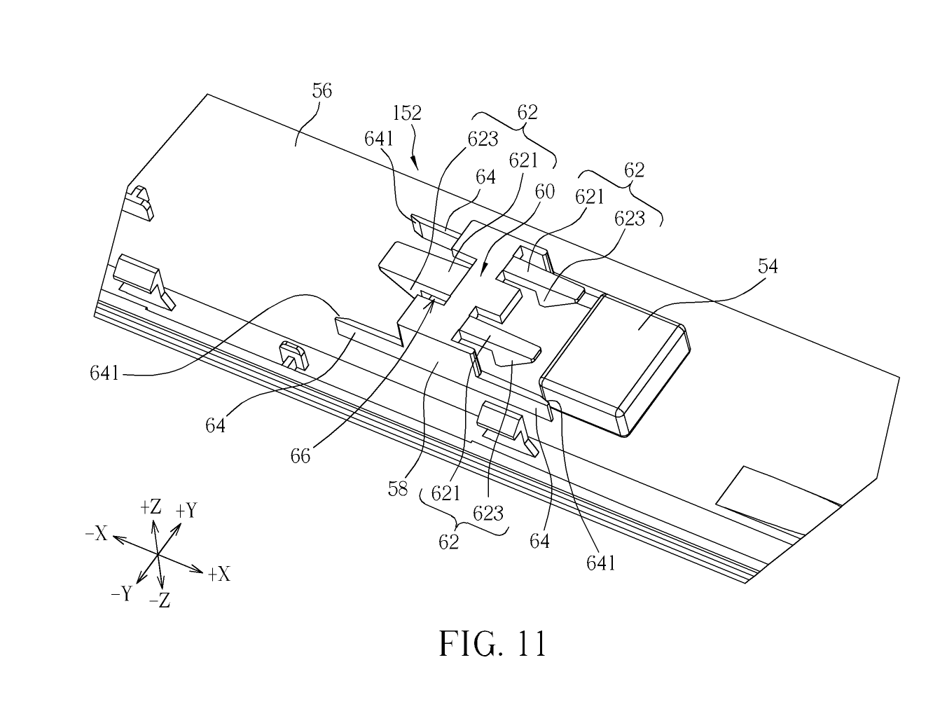

Please refer to FIG. 7 to FIG. 11. FIG. 7 to FIG. 11 are assembly and disassembly diagrams illustrating a fixing mechanism 152 fixing a component 54 according to a second embodiment of the disclosure. The major difference between the second embodiment and the first embodiment is that the fixing mechanism 152 includes three hooks 62. One of the hooks 62 is connected to a side of the top plate 60, and the other two hooks 62 are connected to another side of the top plate 60. Similar to the above-mentioned embodiment, the component 54 lifts the single hook 62 upwards along the inclined surface of the hooking portion 623 of the single hook 62 when being pushed inwards along the guiding rails 64. The component 54 is contained inside the containing space 66 entirely when the component 54 is pushed inwards in +X direction to the end of the lateral wall 58, and the component 54 cannot lift the single hook 62 anymore so that the hook 62 recovers to the undeformed position resiliently and the hooking portions 623 of the three hooks engage the lateral surfaces of the component 54 together. When the component 54 is contained inside the containing space 66, the top plate 60 presses against the component 54 in −Z direction for preventing the component 54 from separating from the containing space 66 upwards. Because the distance between the cantilever portion 621 and the base 56 is greater than the distance between the top plate 60 and the base 56, the top plate 60 can contact against the component 54 and the cantilever portion 621 cannot contact against the component 54. Accordingly, the component 54 only abuts against the top plate 60 in +Z direction instead of lifting the cantilever portion 621 upwards in +Z direction as being applied by external force. As for disassembling the component 54 from the fixing mechanism 152, the two hooks 62 on another side can be lifted upwards and the component 54 can be pulled out in +X direction from another side, and the two hooks 62 can resiliently recover to the undeformed position after taking out the component 54. In this embodiment, the component 54 also can be assembled and disassembled in −X direction on the other way, that is, the component 54 is assembled from the two hooks 62 and disassembled from the single hook 62, and it depends on practical demand.

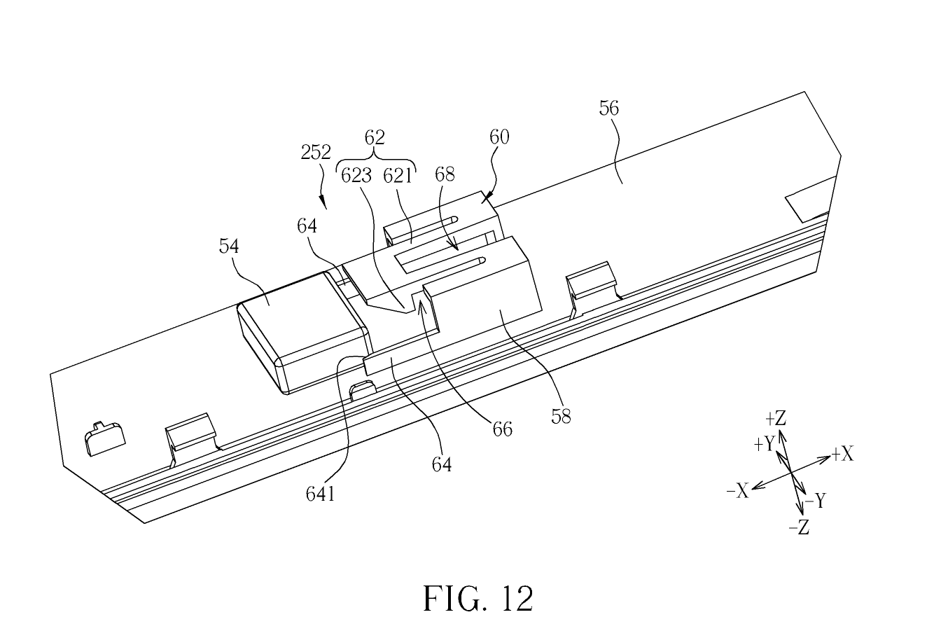

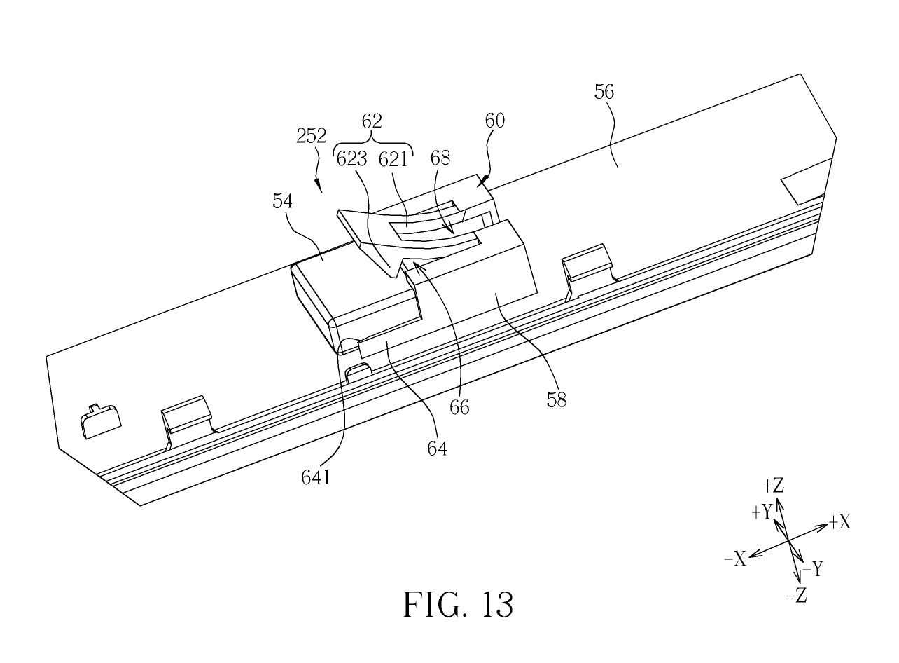

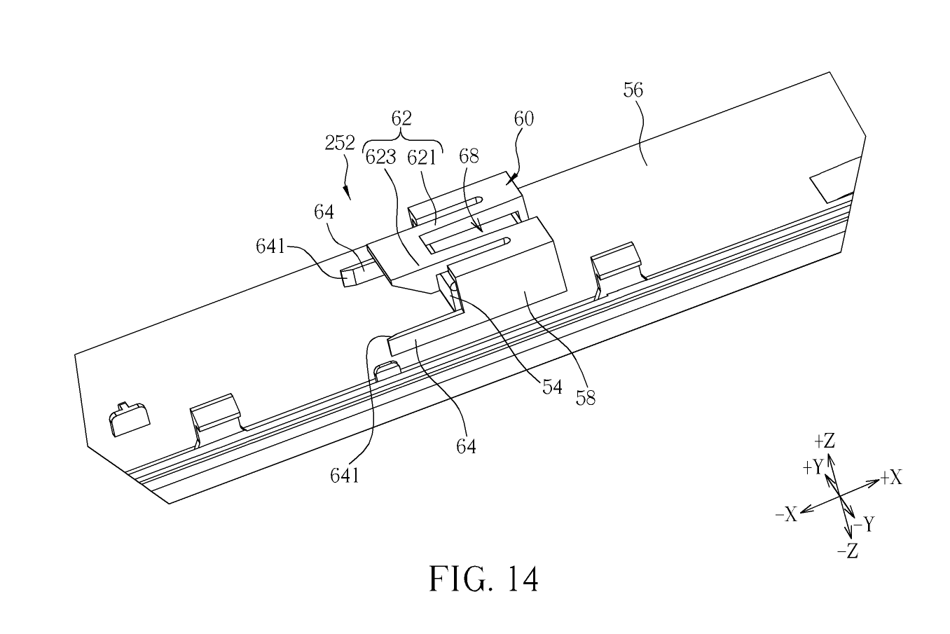

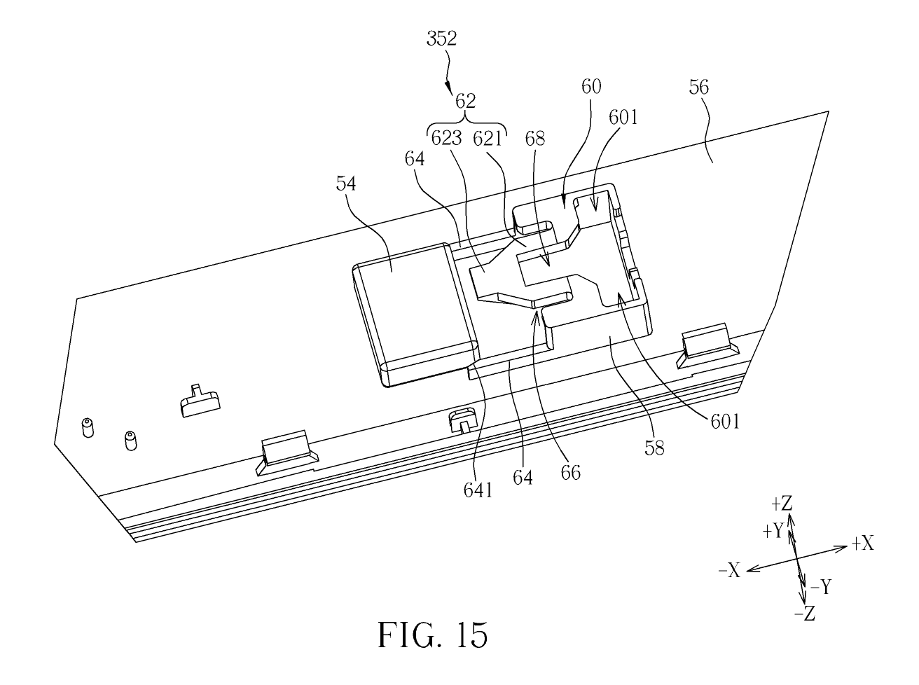

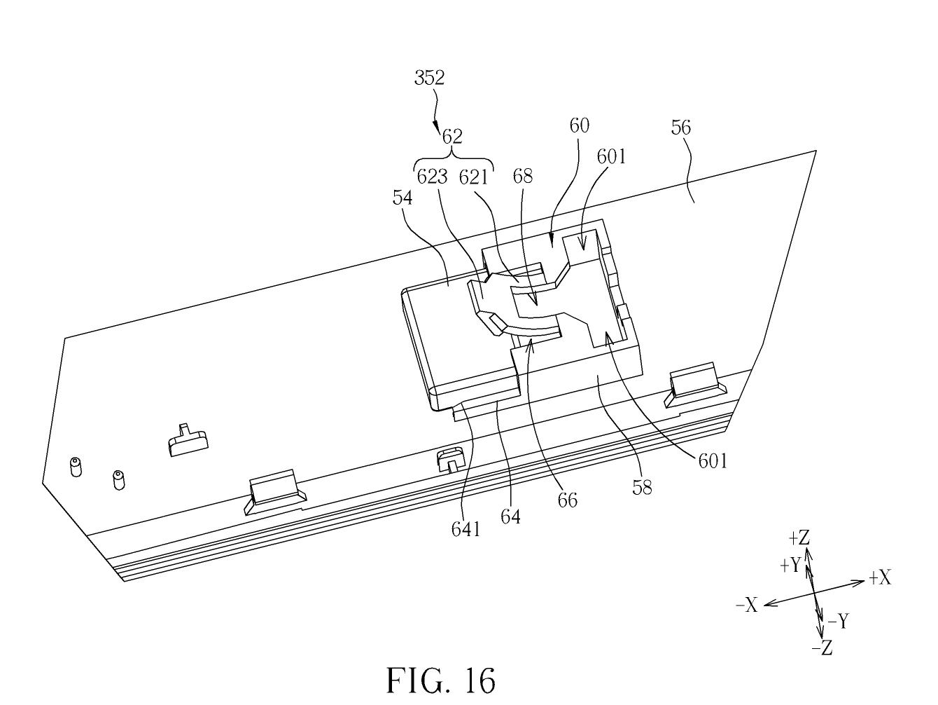

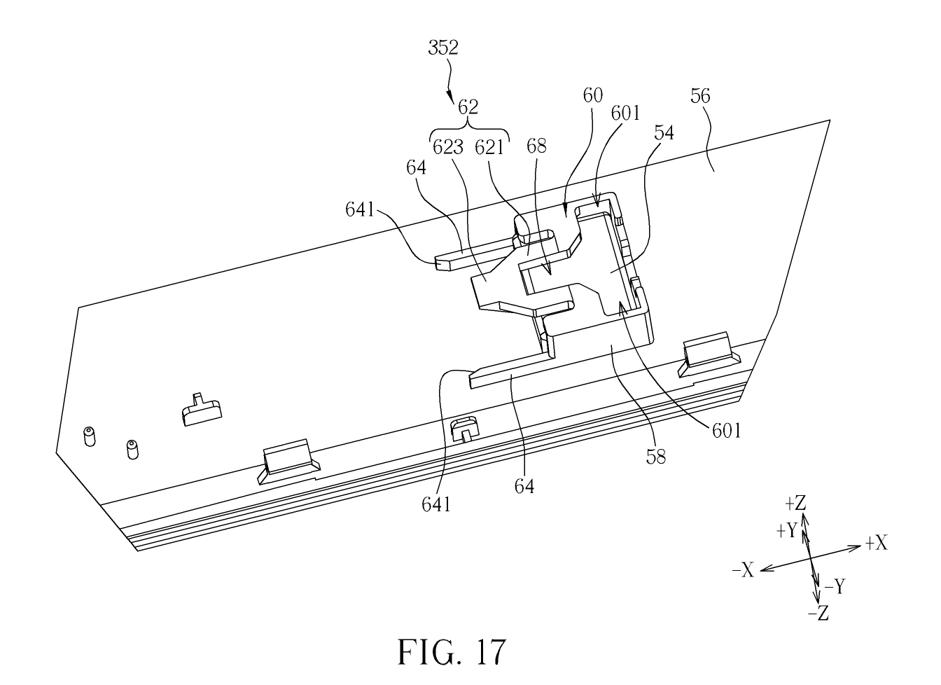

Please refer to FIG. 12 to FIG. 14. FIG. 12 to FIG. 14 are assembly and disassembly diagrams illustrating a fixing mechanism 252 fixing a component 54 according to a third embodiment of the disclosure. The major difference between the third embodiment and the first embodiment is that a slot 68 is formed on the cantilever portion 621 and the top plate 60, such as removing part of the top plate 60 behind the hook 62, for convenient molding and less occupied space of the mold. As for other elements in this embodiment is the same as that mentioned in the aforementioned embodiment, so it is not depicted herein for simplicity. Please refer to FIG. 15 to FIG. 17. FIG. 15 to FIG. 17 are assembly and disassembly diagrams illustrating a fixing mechanism 352 fixing a component 54 according to a fourth embodiment of the disclosure. The major difference between the fourth embodiment and the third embodiment is that two notches 601 are formed on the top plate 60 and connected to the slot 68, such as removing part of the top plate 60 behind the hook 62 and on two sides of the slot 68, for convenient molding, less occupied space of the mold and reducing movement of the mold so as to save manufacturing cost. As for other elements in this embodiment is the same as that mentioned in the aforementioned embodiment, so it is not depicted herein for simplicity.

Compared with the prior art, there is no need to utilize glue to fasten the component, such as the magnetic component for latching the monitor and the host, in the disclosure for solving problems in the prior art. Furthermore, because the distance between the cantilever portion of the hook and the base is greater than the distance between the top plate and the base, the top plate can contact against the component and the cantilever portion can not contact against the component as the component is applied by external force, such as being attracted by other magnetic component. It can prevent deformation of the hook. Besides, the assembly direction of the component is different from the releasing direction of the hook lifted upwards so that the component cannot lift the hook as being contained inside the containing space and the hook can fasten the component stably. Thus, the disclosure provides a fixing mechanism with low assembly cost and preferred fastening effect.

Those skilled in the art will readily observe that numerous modifications and alterations of the device and method may be made while retaining the teachings of the invention.

What is claimed is:

1. A fixing mechanism for fixing a component, the fixing mechanism comprising:
a base;
at least one lateral wall disposed on the base;
a top plate connected to the at least one lateral wall, a containing space being formed between the base, the at least one lateral wall, and the top plate, the top plate pressing against the component in a first direction and the at least one lateral wall abutting against the component laterally when the component is contained inside the containing space; and
at least one hook comprising:
a cantilever portion disposed on a side of the base, and a distance between the cantilever portion and the base being greater than a distance between the top plate and the base so that the component does not push the cantilever portion to lift toward a direction opposite to the first direction as the component is contained inside the containing space; and
a hooking portion connected to the cantilever portion for engaging with a lateral surface of the component in a second direction different from the first direction as the component is placed to be contained inside the containing space in the second direction.

2. The fixing mechanism of claim 1, further comprising at least one guiding rail disposed on the base and connected to the at least one lateral wall, for guiding the component to place into the containing space in the second direction.

3. The fixing mechanism of claim 2, wherein an inclined structure is formed on an end of the at least one guiding rail.

4. The fixing mechanism of claim 1, wherein the cantilever portion is integrated with the top plate monolithically.

5. The fixing mechanism of claim 1, wherein the fixing mechanism comprises threes hooks, one hook is connected to a side of the top plate, and the other two hooks are connected to another side of the top plate.

6. The fixing mechanism of claim 1, wherein the cantilever portion is connected to the top plate, and a slot is formed on the cantilever portion and the top plate.

7. The fixing mechanism of claim 6, wherein two notches are formed on the top plate and connected to the slot.

8. The fixing mechanism of claim 1, wherein an included angle between the hooking portion and the cantilever portion is substantially greater than, equal to, or less than 90 degrees.

9. The fixing mechanism of claim 3, wherein the cantilever portion is integrated with the top plate monolithically.

10. The fixing mechanism of claim 9, wherein the fixing mechanism comprises threes hooks, one hook is connected to a side of the top plate, and the other two hooks are connected to another side of the top plate.

11. The fixing mechanism of claim 9, wherein the cantilever portion is connected to the top plate, and a slot is formed on the cantilever portion and the top plate.

12. The fixing mechanism of claim 11, wherein two notches are formed on the top plate and connected to the slot.

13. The fixing mechanism of claim 3, wherein the fixing mechanism comprises threes hooks, one hook is connected to a side of the top plate, and the other two hooks are connected to another side of the top plate.

14. The fixing mechanism of claim 3, wherein the cantilever portion is connected to the top plate, and a slot is formed on the cantilever portion and the top plate.

15. The fixing mechanism of claim 14, wherein two notches are formed on the top plate and connected to the slot.

16. The fixing mechanism of claim 4, wherein the fixing mechanism comprises threes hooks, one hook is connected to a side of the top plate, and the other two hooks are connected to another side of the top plate.

17. The fixing mechanism of claim 4, wherein the cantilever portion is connected to the top plate, and a slot is formed on the cantilever portion and the top plate.

18. The fixing mechanism of claim 17, wherein two notches are formed on the top plate and connected to the slot.
